(19) United States
(12) Patent Application Publication
(10) Pub. No.: US 2024/0256969 A1
(43) Pub. Date: Aug. 1, 2024

(54) INFORMATION PROCESSING APPARATUS, CONVERSION METHOD AND PROGRAM

(71) Applicant: NIPPON TELEGRAPH AND TELEPHONE CORPORATION, Tokyo (JP)

(72) Inventors: Takayuki MIURA, Tokyo (JP); Satoshi HASEGAWA, Tokyo (JP)

(21) Appl. No.: 18/554,672

(22) PCT Filed: Apr. 22, 2021
(86) PCT No.: PCT/JP2021/016289

§ 371 Date: Oct. 10, 2023

(51) Int. Cl. G06N 20/00

(52) U.S. Cl. CPC G06N 20/00

(57) ABSTRACT

Provided is an information processing device including: an estimation result acquisition unit that acquires estimation result data indicating an estimation result of a machine learning model and first explanation data for explaining the estimation result; and an explanation data conversion unit that converts the first explanation data into second explanation data on the basis of the estimation result data.

### TECHNICAL FIELD

The present invention relates to an information processing device, a conversion method, and a program.

### BACKGROUND ART

Although machine learning such as deep learning is utilized in various fields, there is a problem that it is difficult for humans to understand because the calculation process is complicated. Therefore, in recent years, many efforts have been made to improve the interpretability of machine learning.

Gradient-based explanations, which highlight pixels that are important for classification, are often used to explain deep learning models that perform image classification. Vanilla Gradient (VG) (NPL 1) and Integrated Gradient (IG) (NPL 2) are disclosed as technologies for gradient-based explanation.

### CITATION LIST

### Non Patent Literature

Non Patent Literature 1: Karen Simonyan, Andrea Vedaldi, and Andrew Zisserman. Deep inside convolutional networks: Visualising image classification models and saliency maps. arXiv preprint arXiv: 1312.6034, 2013 Non Patent Literature 2: Mukund Sundararajan, Ankur Taly, and Qiqi Yan. Axiomatic attribution for deep networks. In International Conference on Machine Learning, pp. 3319-3328. PMLR, 2017

### SUMMARY OF INVENTION

### Technical Problem

Comparing IG (first explanation data) and VG (second explanation data), since IG has better overall explanatory power, but VG has simpler information, VG has high utility value in evaluation of model extraction resistance of trained models and data-free knowledge distillation (a kind of model compression technology). Therefore, it is convenient for users of the model to be able to convert the explanation of the machine learning model with the explanation by IG into the VG, but there has been no such technology in the past.

An object of the disclosed technology is to convert first explanation data given as an explanation of a machine learning model into second explanation data.

### Solution to Problem

The disclosed technology relates to an information processing device including: an estimation result acquisition unit that acquires estimation result data indicating an estimation result of a machine learning model and first explanation data for explaining the estimation result; and an explanation data conversion unit that converts the first explanation data into second explanation data based on the estimation result data.

### Advantageous Effects of Invention

The first explanation data given as an explanation of the machine learning model can be converted into the second explanation data.

### BRIEF DESCRIPTION OF DRAWINGS

FIG. 1 is a functional configuration diagram of an explanation conversion system.

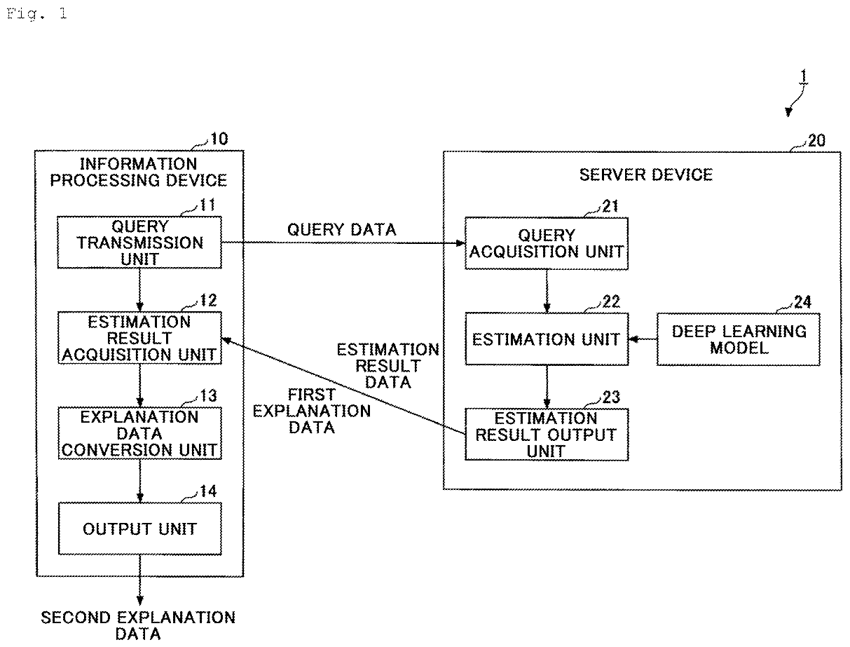

FIG. 2 is a diagram illustrating an example of an algorithm for explanation conversion processing.

FIG. 3 is a flowchart illustrating an example of a flow of explanation conversion processing.

FIG. 4 is a diagram illustrating a hardware configuration example of an information processing device.

### DESCRIPTION OF EMBODIMENTS

Hereinafter, an embodiment of the present invention (the present embodiment) will be described with reference to the drawings. The embodiment described below is merely an example, and embodiments to which the present invention is applied are not limited to the following embodiment.

An explanation conversion system 1 according to the present embodiment includes an information processing device 10 and a server device 20. The information processing device 10 and the server device 20 are communicatively connected to each other via a communication line or the like.

The information processing device 10 transmits query data to the server device 20. The server device 20 executes estimation processing on the basis of the received query data, and transmits estimation result data and first explanation data to the information processing device 10. The information processing device 10 converts the received first explanation data into second explanation data and outputs the second explanation data.

The first explanation data is explanation data given to the estimation result data by Integrated Gradient (IG) (NPL 2). The second explanation data is explanation data given to the estimation result data by Vanilla Gradient (VG) (NPL 1).

The information processing device 10 includes a query transmission unit 11, an estimation result acquisition unit 12, an explanation data conversion unit 13, and an output unit 14.

The query transmission unit 11 transmits query data to the server device 20 in response to a user's operation or the like. The estimation result acquisition unit 12 acquires estimation result data and first explanation data from the server device 20. The explanation data conversion unit 13 converts the first explanation data into second explanation data.

The output unit 14 outputs the converted second explanation data. Specifically, the output unit 14 displays an image indicating the second explanation data on a screen, or transmits the second explanation data to another device or the like.

The server device 20 includes a query acquisition unit 21, an estimation unit 22, an estimation result output unit 23, and a deep learning model 24.

The query acquisition unit 21 acquires query data from the information processing device 10. The estimation unit 22 executes estimation processing on the query data by using the deep learning model 24.

Here, the estimation unit 22 assigns first explanation data to the estimation result data by IG. The estimation result output unit 23 outputs the estimation result data and the first explanation data to the information processing device 10.

The deep learning model 24 is an example of a machine learning model. The deep learning model 24 is, for example, a neural network whose activation function is a rectified linear unit (ReLU), but is not limited thereto.

### (Operation of Information Processing Device)

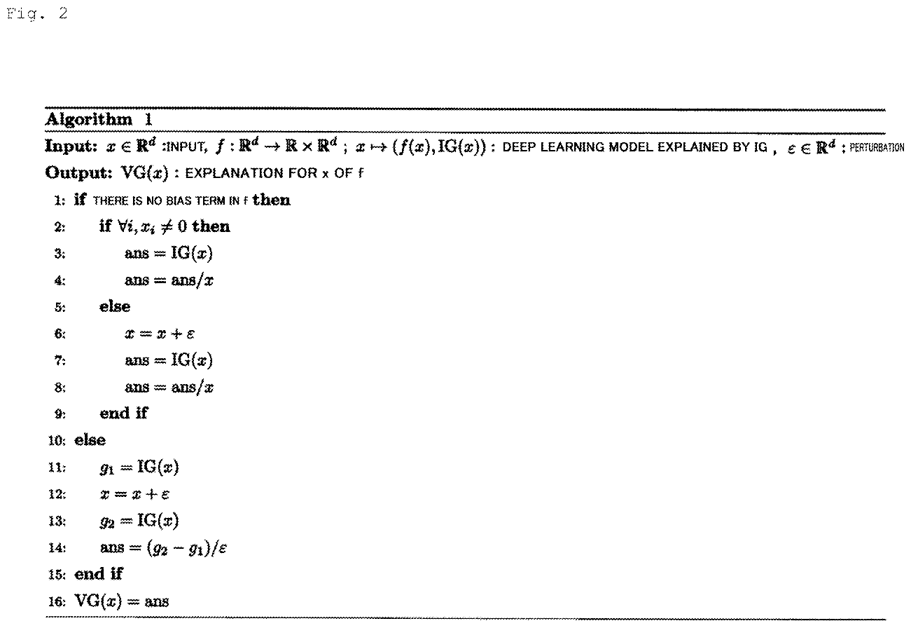

FIG. 2 is a diagram illustrating an example of an algorithm for explanation conversion processing. The information processing device 10 converts the first explanation data into the second explanation data by using the algorithm shown in FIG. 2 in the explanation data conversion unit 13.

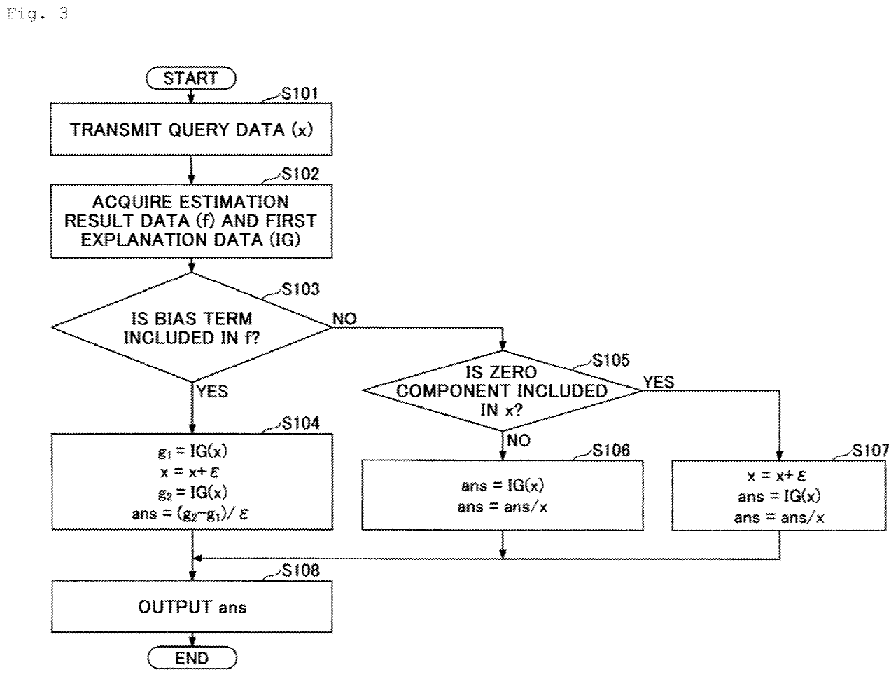

FIG. 3 is a flowchart illustrating an example of a flow of explanation conversion processing.

FIG. 3 is a flowchart illustrating the flow of processing using the algorithm shown in FIG. 2. The query acquisition unit 21 of the information processing device 10 transmits query data upon receiving a user's operation or the like (step S101).

The input query data is as follows.

$$x ∈ {ℝ}^{d} \qquad [ Math . 1 ]$$

Next, the estimation result acquisition unit 12 acquires estimation result data and first explanation data (step S102). Estimation result data (f) and first explanation data (IG) are represented as follows.

$$f : {ℝ}^{d} \to ℝ \times {ℝ}^{d} ; x ↦ ( f ( x ) , IG ( x ) ) \qquad [ Math . 2 ]$$

Next, the explanation data conversion unit 13 determines whether or not a bias term is included in the estimation result data (f) (step S103). When it is determined that the bias term is included in the estimation result data (f) (step S103: Yes), the explanation data conversion unit 13 calculates second explanation data (ans) as follows (step S104).

$${g}_{1} = IG ( x )$$

$$x = x + ε$$

$${g}_{2} = IG ( x )$$

$$ans = ( g 2 - g 1 ) / ε$$

Here, ε is a sufficiently small perturbation, and is represented as follows.

### [Math. 3]

$$ε ∈ {ℝ}^{d}$$

When it is determined that the bias term is not included in the estimation result data (f) (step S103: No), the explanation data conversion unit 13 determines whether or not a zero component is included in x (step S105).

When it is determined that the zero component is not included in x (step S105: No), the explanation data conversion unit 13 calculates second explanation data (ans) as follows (step S106).

$$ans = IG ( x )$$

$$ans = ans / x$$

Also, when it is determined that the zero component is included in x (step S105: Yes), the explanation data conversion unit 13 calculates second explanation data (ans) as follows (step S107).

$$x = x + ε$$

$$ans = IG ( x )$$

$$ans = ans / x$$

Following step S104, S106 or S107, the output unit 14 outputs the calculated ans (step S108).

The deep learning model 24 has local linearity, for example, when it is a neural network whose activation function is ReLU. Therefore, when there is no bias term in f, the relationship between IG and VG is as follows.

$$IG ( x ) = x ⊙ VG ( x ) \qquad [ Math . 4 ]$$

When there is a bias term in f, the relationship between IG and VG is represented by a sufficiently small vector E as follows.

$$IG ( x + ε ) - IG ( x ) = ε ⊙ VG ( x ) \qquad [ Math . 5 ]$$

The above-described explanation conversion processing is processing for utilizing such features. The second explanation data (VG) output as the result of the explanation conversion processing is as shown in Table 1 below.

TABLE 1

| | There is no bias term in f | There is bias term in f |
|---|---|---|
| There is no zero | IG(x)/x | (IG(x + ε) − IG(x))/ε |
| component in x | | |
| There is zero | IG(x + ε)/(x + ε) | (IG(x + ε) − IG(x))/ε |
| component in x | | |

### (Hardware Configuration Example According to Present Embodiment)

The information processing device 10 can be implemented, for example, by causing a computer to execute a program describing the processing details described in the present embodiment. Note that this “computer” may be a physical machine or a virtual machine on the cloud. When using a virtual machine, the “hardware” described here is virtual hardware.

The above program can be stored and distributed by being recorded in a computer-readable recording medium (portable memory or the like). Furthermore, the above program can also be provided through a network such as the Internet or an electronic mail.

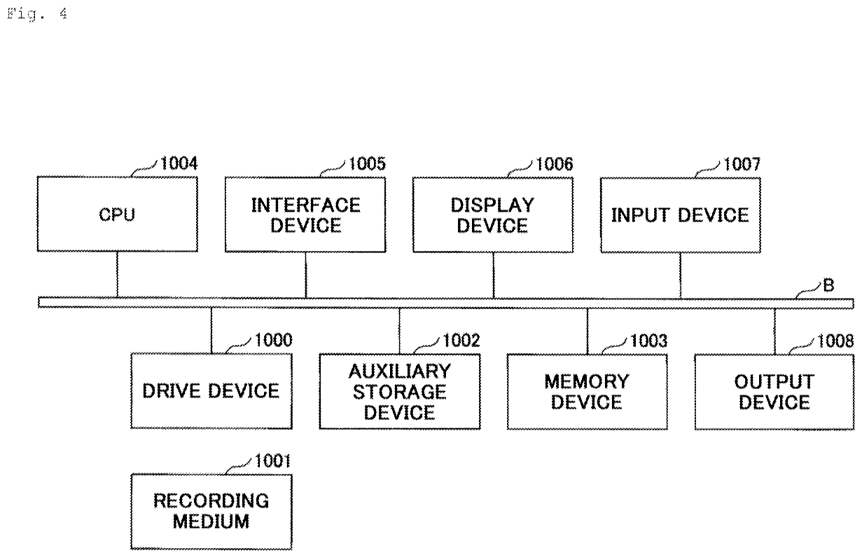

FIG. 4 is a diagram illustrating a hardware configuration example of the computer. The computer illustrated in FIG. 4 includes a drive device 1000, an auxiliary storage device 1002, a memory device 1003, a CPU 1004, an interface device 1005, a display device 1006, an input device 1007, an output device 1008, and the like, which are connected to each other via a bus B.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 through the drive device 1000. However, the program need not necessarily be installed from the recording medium 1001, and may be downloaded from another computer via a network. The auxiliary storage device 1002 stores the installed program and stores necessary files, data, and the like.

The memory device 1003 reads and stores the program from the auxiliary storage device 1002 when there is an instruction to start the program. The CPU 1004 implements functions related to the device according to the program stored in the memory device 1003. The interface device 1005 is used as an interface for connection to a network. The display device 1006 displays a graphical user interface (GUI) or the like according to a program. The input device 1007 includes a keyboard and mouse, buttons, a touch panel, or the like, and is used to input various operation instructions. The output device 1008 outputs a calculation result.

The information processing device 10 according to the present embodiment converts the first explanation data into the second explanation data. Thus, the user can consider the behavior of the machine learning model while comparing the first explanation data with the second explanation data or by any appropriate explanation data.

### Summary of Embodiment

This specification describes at least the information processing device, the conversion method, and the program described in each of the following items.

### Item 1

An information processing device including:
an estimation result acquisition unit that acquires estimation result data indicating an estimation result of a machine learning model and first explanation data for explaining the estimation result; and
an explanation data conversion unit that converts the first explanation data into second explanation data based on the estimation result data.

### Item 2

The information processing device according to Item 1, wherein the explanation data conversion unit determines whether or not a bias term is included in the estimation result data, and converts the estimation result data into the second explanation data including perturbation when the bias term is included.

### Item 3

The information processing device according to Item 2, wherein the explanation data conversion unit determines whether or not a zero component is included in query data input to the machine learning model when the bias term is not included, and converts the query data into the second explanation data including the perturbation when the zero component is included.

### Item 4

The information processing device according to any one of Items 1 to 3, wherein the machine learning model is a neural network whose activation function is ReLU.

### Item 5

The information processing device according to any one of Items 1 to 4,
wherein the first explanation data is explanation data by Integrated Gradient (IG), and
the second explanation data is explanation data by Vanilla Gradient (VG).

### Item 6

A conversion method executed by a computer, the method including:
a step of acquiring estimation result data indicating an estimation result of a machine learning model and first explanation data for explaining the estimation result; and
a step of converting the first explanation data into second explanation data based on the estimation result data.

### Item 7

A program for causing a computer to function as each unit in the information processing device according to any one of Items 1 to 5.

Although the embodiment has been described above, the present invention is not limited to such a specific embodiment, and various modifications and changes can be made within the scope of the gist of the present invention described in the claims.

### REFERENCE SIGNS LIST

1 Explanation conversion system
10 Information processing device
11 Query transmission unit
12 Estimation result acquisition unit
13 Explanation data conversion unit
14 Output unit
20 Server device
21 Query acquisition unit
22 Estimation unit
23 Estimation result output unit
24 Deep learning model
1000 Drive device

1. An information processing device comprising:
a processor; and
a memory storing program instructions that cause the processor to:
acquire estimation result data indicating an estimation result of a machine learning model and first explanation data for explaining the estimation result; and
convert the first explanation data into second explanation data based on the estimation result data.

2. The information processing device according to claim 1, wherein the processor determines whether or not a bias term is included in the estimation result data, and converts the estimation result data into the second explanation data including perturbation when the bias term is included.

3. The information processing device according to claim 2, wherein the processor determines whether or not a zero component is included in query data input to the machine learning model when the bias term is not included, and converts the query data into the second explanation data including the perturbation when the zero component is included.

4. The information processing device according to claim 1, wherein the machine learning model is a neural network whose activation function is ReLU.

5. The information processing device according to claim 1,
wherein the first explanation data is explanation data by Integrated Gradient (IG), and the second explanation data is explanation data by Vanilla Gradient (VG).

6. A conversion method executed by a computer, the method comprising:
acquiring estimation result data indicating an estimation result of a machine learning model and first explanation data for explaining the estimation result; and
converting the first explanation data into second explanation data based on the estimation result data.

7. A non-transitory computer-readable recording medium storing a program for causing a computer to execute a conversion method comprising:
acquiring estimation result data indicating an estimation result of a machine learning model and first explanation data for explaining the estimation result; and
converting the first explanation data into second explanation data based on the estimation result data.
